(19) United States
(12) Patent Application Publication
(10) Pub. No.: US 2005/0240427 A1
(43) Pub. Date: Oct. 27, 2005

(54) Energy management method and process using analytic metrics.

(76) Inventor: Henry B. Crichlow, Norman, OK (US)

Correspondence Address: HENRY CRICHLOW, 330 W. GRAY ST., SUITE 504, NORMAN, OK, 73069, US

(21) Appl. No.: 10/907,926

(22) Filed: Apr. 21, 2005

Related U.S. Application Data
(60) Provisional application No. 60/564,995, filed on Apr. 26, 2004.

(51) Int. Cl. G06F 17/60

(52) U.S. Cl. 705/1

(57) ABSTRACT

A method and process provides an approach to optimizing energy costs or any similar fungible, consumable commodity in real time use by defining and utilizing a novel analytic metric based on the ratio of the actual cumulative cost of the commodity used compared to the absolute minimum cost of the commodity during the time period under consideration. The historical energy management approach uses the price of the commodity and then tries to lower the total cost of energy use during the most expensive time periods. It may not be possible with the existing energy management techniques to be able to meet all the operational requirements of the user and still have the minimum cost of use. As a result of this invention, the user can be guaranteed the optimal energy use at the absolute minimum cost, and if the minimum is not achievable the invention allows the user to quantify how efficient his operation is, compared to the theoretical optimum. The use of a new metric called the Energy Performance Index (EPI) allows this comparison to be made across all energy use platforms. Substantial increases in efficiency, performance and economics can be achieved with this invention.

### CROSS REFERENCE TO RELATED APPLICATIONS

This application claims priority from provisional application No. 60/564,995 filed Apr. 26, 2004 and Disclosure Document 547,087 filed Feb. 17, 2004 by Dr. Henry Crichlow. This application is related to application Ser. No. 10/016,049 filed Dec. 12, 2001, application Ser. No. 10/033,667, filed Dec. 27, 2001 and application Ser. No. 60/564,738 filed Apr. 26, 2004 filed by the inventor.

### INTRODUCTION

Usually, a customer buys energy from the utility or power provider during the 24-hour day and this power will be price-sensitive to the time of day. This is called the time-of-use (TOU) tariff. The customer has varying needs during the day and it is usually possible to change his daily usage pattern to minimize energy costs. If the customer were able to choose the optimal combination of usage during the day that meets all his operational constraints and to make the usage coincide with the least cost, the user will have the absolute minimum cost of energy use. This level of perfection is usually impossible to achieve in real world situations therefore a protocol is needed to quantify the ability of the user to reach as near to perfection as possible. The new invention puts forth this method and process.

### BACKGROUND OF THE INVENTION

1. Field of Invention

This invention is a unique, innovative method and process that enables millions of commercial and industrial customers to determine how efficient is the level of their energy use. Also, by examining the new metric developed in this invention, customers can ascertain which processes can be initiated to optimize their use, lower their costs in real time, while still meeting all their operational requirements. Use by residential customers is also possible with this invention, though the actual dollar savings are not as significant on residential systems.

Hitherto, most energy management has been attempted to lower costs by using the most power during the least expensive time intervals. Given the fact that it is physically impossible to use more than some maximum amount of energy in a given time period, a mechanism must be developed to allocate energy use and also to determine how close to perfection or optimality the preferred process has reached.

The industry focus has always been needing to determine costs from historical data, as well as to change operational processes for future management. Power producers have usually called major energy users, asking them to voluntarily curtail their use of power at certain times during the day to minimize overall demand in a region and thereby lower total generating expenses. The TOU tariffs provided by the utilities try to initiate the curtailment voluntarily by making the user realize what savings can be obtained by shifting power use. These have not always been successful since the user did not have the technology to determine in real time how efficient his energy management process has been.

In one aspect of the invention, a method is provided for determining a new and innovative metric, the Energy Performance Index (EPI). This metric is defined as “the ratio of the optimized absolute minimum cost of available energy used in a given period of time that meets all the operational constraints and target values relative to actual un-optimized cost of energy during the same time period”. The EPI ranges from 0.0 to 1.000.

The EPI provides the customer with a true cost of the energy use and at the same time lets the user know how much improvement is possible in the efficient utilization of the energy. In a perfect situation the EPI is 1.000, however most users will have EPI values substantially less and showing the need for improvement.

The benefits of the EPI are several. Companies can modify their operations to optimize their energy use and to bring their EPI closer to unity. By doing so they minimize their total operating costs and improve their bottom line. It can also objectively show how the company ranks compared to other companies in its area and its industry.

One aspect of this invention develops the algorithms that are used to compute EPI and the process to provide the EPI on a continuous basis to the end user.

The method comprises of the following steps for an energy example but can be modified to utilize any commodity in commerce like natural gas, water, electronic bandwidth usage among others:

Collect the TOU tariff data from the utility or similar provider of the energy product that is being utilized. This data provides the hourly cost of energy for each hour during the subject time period.

Determine the total target usage requirement of the energy.

Compute the total cost of un-optimized energy use during the subject time period.

Determine what are the hourly maximum operational constraints for the facility.

Determine what are the hourly minimum operational constraints for the facility.

Determine what are the hourly equality operational constraints for the facility.

Formulate the optimization model using the required algorithms and the appropriate objective function and the attendant constraints for the operations. The optimization algorithms are well published are not part of this invention.

Solve the optimization model.

Compute the absolute minimum cost of energy using the published TOU costs and the optimal allocation of energy during the time period.

Compute the EPI using the data from the steps above by comparing the un-optimized energy costs to the optimized costs.

This ratio of the optimized absolute minimum cost of available energy used in a given period of time that meets all the operational constraints and target values relative to actual un-optimized cost of energy during the same time period is the EPI.

2. Description of Prior Art

Numerous inventions have been proposed for energy management and for comparing energy usage by customers. Williams Corporation (Ref. 1) has described the Universal Energy unit or UE^{sm} which is a single cross-commodity value for pricing energy. This metric aggregates and compares different units like megawatts, MMBTUs and barrels into a single measure. The metric is used for historical, real time and for future pricing of energy. The British Thermal Unit, BTU (Ref 2.) was defined over 100 years ago to measure and quantify heat in engineering operations.

Prior inventions in this area of energy management, have usually been limited to either hardware or software solutions.

First, hardware solutions are taught by U.S. Pat. No. 6,476,592, which describes a device for displaying immediate and accumulated energy consumption.

U.S. Pat. No. 5,170,051 describes a sensor device for determining electric energy consumption.

U.S. Pat. No. 5,061,890 digitally measures alternating current from a transmission line by deducing the time derivative of the magnetic field induced in the current flowing.

U.S. Pat. No. 4,351,028 demonstrates a consumption meter responsive to voltage and current and coupled to tariff and clock information. In general, these hardware devices have been used to measure and display energy use and to alarm, warn or shut off energy use at some preset limit.

In addition, hardware solutions have included controllers to minimize energy use on equipment or devices. Finally hardware sensors, which reduce peak energy loads directly or indirectly on equipment. All these techniques suffer from several limitations and inherent problems. It is possible that due to alarming and energy curtailment, the user may not be able to use all the energy the customer requires in a given time period. This may lead to under-use and overuse of energy and its subsequent economic costs to the customer.

Secondly, software solutions as taught in U.S. Pat. No. 6,088,688, which describes a massive computerized utility management multi-user and energy tracking accounting method, provides viewable historical data for customers.

U.S. Pat. No. 6,603,218 describes a method to manage energy consumption in a domestic environment in which appliances are connected to a network.

U.S. Pat. No. 5,432,71 0 optimizes a system wide energy supply and a fuel cell system by minimizing a linear equation, which describes the functioning of the system. These software systems are generally utilized to monitor, aggregate, account, optimize, record, and display energy use data that has long been utilized in a historical mode.

U.S. Pat. No. 5,812,422 describes a method for optimizing energy efficiency in a lighting system with a plurality of light sources. The system described includes the use of a linear programming algorithm coupled with a set of constraints to provide allocation of energy to each light source, which satisfies a total energy constraint for the plurality of lights and allocates the optimal amount of energy to each light in the system.

All these embodiments have suffered from several shortcomings. For instance, there is usually no ability to control the future use if you have only historical data to use solely in a review mode. Again, there is no economic parameter used in optimizing these energy management processes. There is no guarantee of optimality and/or that actual customer operations will provide for efficient energy utilization and cost reductions in the time period under study.

By reviewing the prior art, it is clear that there is a need for a system that guarantees the absolute optimization of energy efficiency based upon economic parameters, as well as operational constraints, in a process that the customer can utilize easily, continuously economically, and in real time. This invention described herein allows the customer to determine the optimal use of energy over a time period and to utilize this data in making future decisions. Optimality is critical today, especially when prices for the same amount of a commodity as energy can have a several-fold price increase over a 24-hour period and can have a significant effect on the operating expenses of a company. The use of the algorithmic processes provided herein guarantee that there is a global minimum since the optimizing models widely known in the operations research disciplines to guarantee and are proven to provide global extremas. The present invention overcomes many of the difficulties in the prior art with a novel computer implemented approach.

### SUMMARY OF THE INVENTION

This present invention encompasses a novel technique for significantly reducing the cost of the total energy used during a specific time interval by a combination of TOU tariffs and optimization algorithms that provide a new metric the Energy Performance Index (EPI). This EPI allows the user simultaneously to optimize energy efficiency and economics. The invention includes the steps of defining a set of parameters for the physical processes or operations being analyzed, defining an optimization model and solving this optimization using a set of appropriate constraints such that the user meets a target energy constraint with a minimum cost over a specified time interval and computing the EPI metric from this optimal solution. The EPI as defined earlier ranges from 0.0 to 1.000.

The EPI provides the customer with a true cost of the energy use and at the same time lets the user know how much improvement is possible in the utilization of the energy. In a perfect situation the EPI is 1.000, however most users will have EPI values substantially less and showing the need for improvement.

The benefits of the EPI are such that companies can modify their operations to optimize their energy use and to bring their EPI closer to unity. By so doing they minimize their total operating costs and improve their bottom line. This invention teaches the methodology and shows the algorithms to compute and provide the EPI on a continuous basis to the end user. Users can immediately and objectively compare their companies and their operations to others using this novel metric.

### BRIEF DESCRIPTION OF THE DRAWINGS

These and other features of the subject invention shall be better understood in relation to the detailed description taken in conjunction with the drawings of shown below.

FIG. 1 Computer system connected to the Internet

FIG. 2 Overview of the energy billing process.

FIG. 3 Time of Use schedule showing electric power cost variation during the time of day.

FIG. 4 Table showing the minimum and maximum limits at each hour during the day.

FIG. 5 Table showing the optimal allocation of electric power during the day and the cumulative use of electric power meeting the target value.

FIG. 6 Shows a generalized optimization model.

FIG. 7 Flow chart of process to determine EPI.

FIG. 8 Flow chart showing computation and display of output information to the internet.

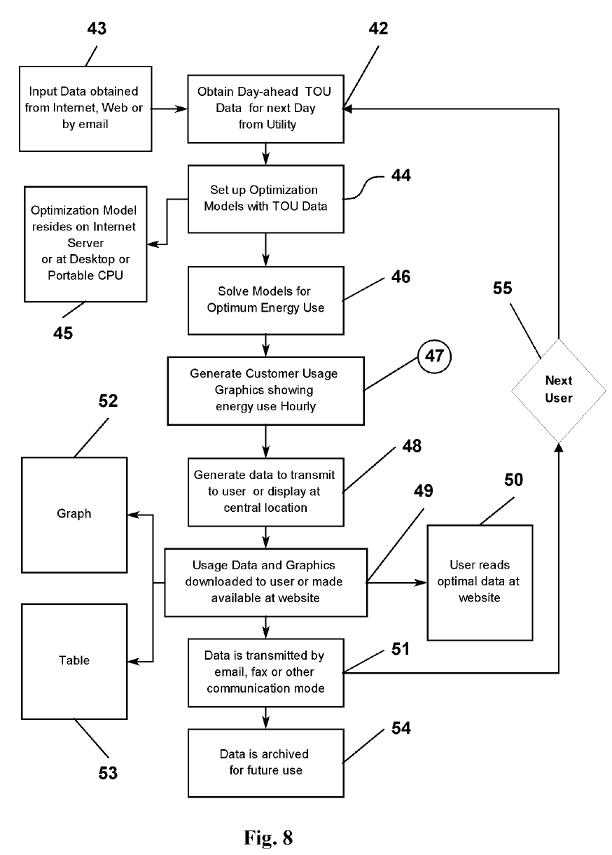

FIG. 9 Graphical display of TOU tariff hourly data.

FIG. 10 Example of computed interval hourly energy cost.

FIG. 11 Example graphic of cumulative hourly energy cost.

FIG. 12 Hourly maximum and minimum limits or constraints of operational energy use.

FIG. 13 Example of hourly energy savings based on optimization.

### DESCRIPTION OF ELEMENTS OF THE PREFERRED EMBODIMENTS

A preferred embodiment of the techniques of the present invention will now be described in the context of a typical energy management operation. Those skilled in the art however, will recognize that the central ideas of the invention are not limited to the details enumerated below.

The customer has a specific total requirement for energy use in a specific time period, usually a 24 hour day.

The utility provides a TOU tariff detailing the cost of energy at predetermined time intervals, usually hourly.

The user has to modify his operations to shift power use and take advantage of the cost differentials in each time interval.

The user needs to determine the best way of shifting load to minimize costs and still meet his operational requirements.

The user uses this invention, which provides the new allocation process for energy and a guaranteed minimum cost of energy.

The computation of the EPI metric is then used to quantify energy management efficiency.

The Optimization Process: This energy management process can be linear or non-linear depending on the formulation of the operational problem and its constraints. This embodiment discussed herein is for linear systems but this does not limit the application of the process and method and anyone skilled in the art can easily modify the models to use non-linear systems and non-linear algorithms in solving the problems. These systems are discussed in many textbooks and also in Ref. (3). A linear model formulation is discussed below:

AS shown in Ref. 4, a Linear Programming problem is a special case of a Mathematical Programming problem. From an analytical perspective, a mathematical program tries to identify an extreme (i.e., minimum or maximum) point of a function, which furthermore satisfies a set of constraints which describe the limits of the system process. Linear programming is the specialization of mathematical programming to the case where both the function to be optimized is called the objective function—and the problem constraints are linear.

From an applications perspective, mathematical (and therefore, linear) programming is an optimization tool, which allows the rationalization of many managerial and/or technological decisions required by contemporary techno-socio-economic applications. An important factor for the applicability of the mathematical programming methodology in various application contexts, is the computational tractability of the resulting analytical models. Under the advent of modern computing technology, this tractability requirement translates to the existence of effective and efficient algorithmic procedures able to provide a systematic and fast solution to these models. For Linear Programming problems, the Simplex algorithm, provides a powerful computational tool, able to provide fast solutions to very large-scale applications, sometimes including hundreds of thousands of variables (i.e., decision factors). In fact, the Simplex algorithm was one of the first Mathematical Programming algorithms to be developed in 1947, and its subsequent successful implementation in a series of applications significantly contributed to the acceptance of the broader field of Operations Research as a scientific approach to decision making. The linear model is shown below:
Minimize ΣCⱼ*Xⱼ Eq. 1

Subject to:
ΣAᵢⱼ*Xⱼ>=Upper Limitᵢ Eq. 2
and:
ΣBᵢⱼ*Xⱼ>=Lower Limitᵢ Eq. 3
Xⱼ>=0 Eq. 4

Where Cⱼ are the costs of energy at each hour “j” and Xⱼ is the amount of energy used in each hour “j”.

and, the constants Aᵢⱼ and Bᵢⱼ are coefficients of the constraint equations of the model.

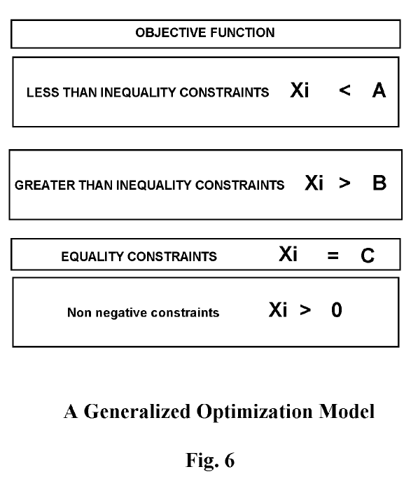

The objective function is shown in Eq.1, such that operational constraints are shown in Eq. 2 and Eq. 3 and the non-negative restrictions are shown in Eq. 4. FIG. 6 shows a generalized format of an optimization model. The solution is obtained by applying the Simplex algoritmm or similar algorithm to solve the problem which provides the optimal values of the variable Xⱼ.

### OPERATION OF THE INVENTION

The operation comprises the following steps:

TOU data is collected. It is usually provided for the upcoming 24 hour period by the utility in what is called in the industry, “day-ahead” mode. This data provides the time variation of the cost of energy.

User needs for the total time are quantified in a single target number or scalar. That number is the target total energy needed in a given time, e.g. 24 hour day, by the physical process or operation.

The invention is used to allocate the least expensive utilization of power, substantially in real time, that meets the total requirements of the user within the limits set by the constraints and to simultaneously guarantee the MINIMUM cost of energy used.

The EPI is computed substantially in real time from the outputs of the optimization model using the formula provide later herein.

The user can compare his operations with those in the industry or to his past operations to make modifications in the way his operations are conducted.

The EPI data and graphics are made available to the customers via the Internet or by email or fax or other communication modes.

### DETAILED DESCRIPTION OF THE INVENTION

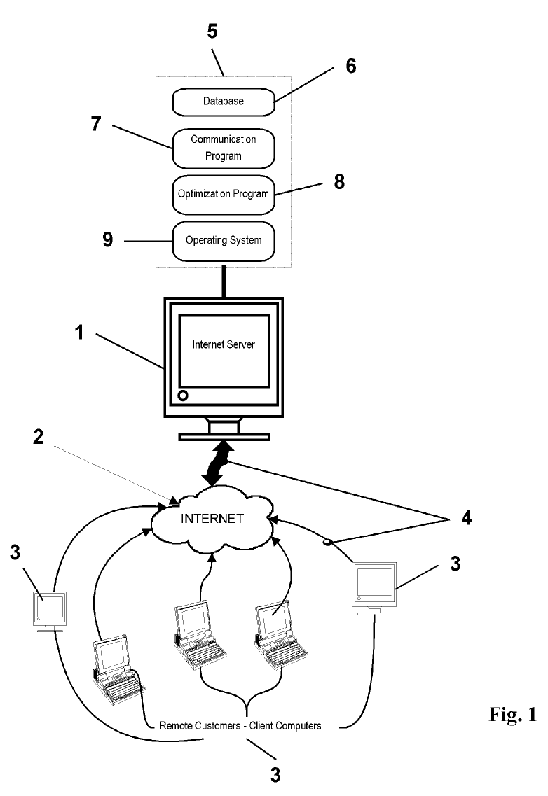

These and various features of the subject invention will be readily understandable with reference to the accompanying drawing and the following detailed description. FIG. 1 is an overview of the computer system showing the internet server 1, connected to a global communication network, the internet 2, and remote customer or client computers 3 also connected to the internet 1. Also, within the internet server 1 are present a suite of programs 5, specifically but not limited to relational database 6, communication programs 7, optimization algorithm programs 8 and operating systems 9.

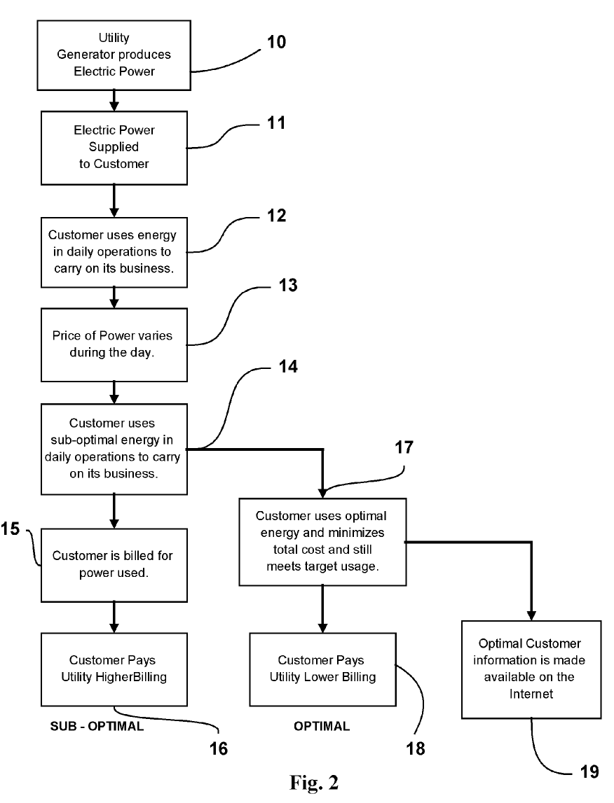

FIG. 2 displays a generalized overview of the two operational alternatives for energy management. In the first, sub-optimal approach shown by steps 10, 11, 12, 13, 14, 15, 16, the customer can use a non-optimized approach in which the power is used as delivered to the customer with no reallocation of use during the day by the customer. In the second approach, the optimized approach shown by steps 10, 11, 12, 13, 14, 17, 18, the customer rearranges his energy usage during the day to optimize operations and minimize the cost of energy. In the optimized case an added feature of this invention is that the data in available online in step 19, for immediate interaction by the customer to keep his operations optimized at all times in real time.

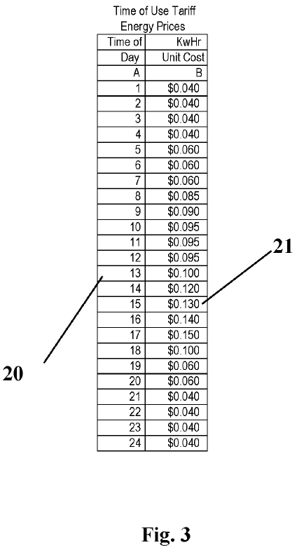

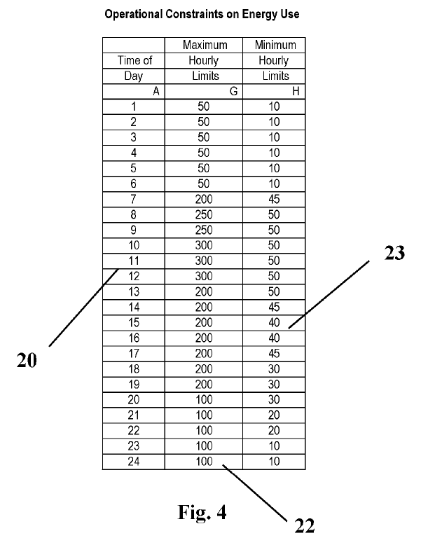

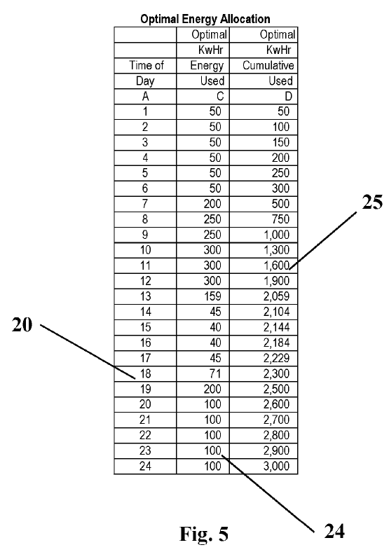

With reference to FIG. 3 we see a typical time of use (TOU) tariff for electric power. The table shows that at various hours, 20 during the 24 hour cycle, the cost of energy 21 based on a kilowatt-hour unit varies from a low value usually during weak demand times to the highest values during the greatest demand time frames. This TOU tariff is usually provided by the utility at least on a “day-ahead” schedule so that the customer can adequately prepare to utilize the information in planning its operations. FIG. 4 shows an example of the limits or constraints that are operationally imposed on the customer by the way in which he does business. There are generally upper limits 22, and lower limits 23 but equality limits are also possible. In FIG. 5 we show an example of optimized set of output parameters for a case in which the target electric use was 3,000 units during the 24 hour time period. The time column is shown by 20, the optimal energy use in any given time period is shown by 24 and the cumulative values 25 are the rightmost column.

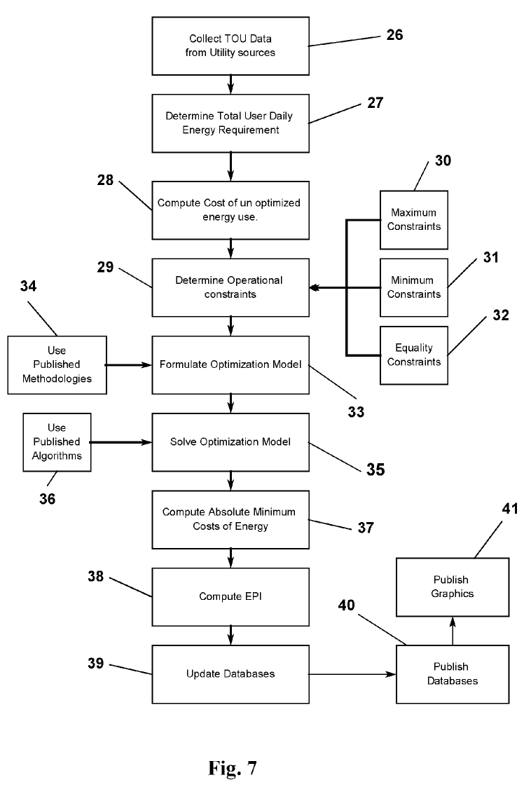

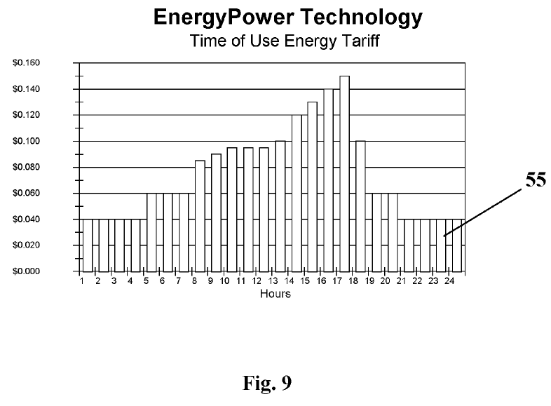

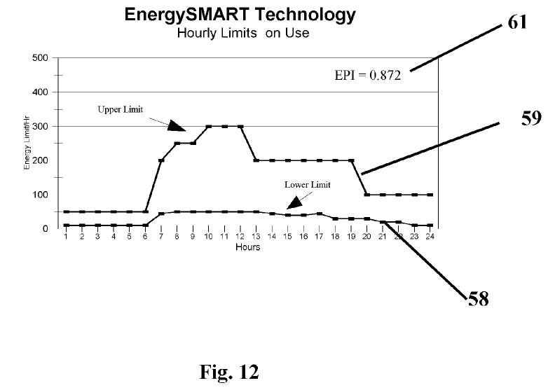

With reference to FIG. 7, in step 26, the TOU data shown as a table in FIG. 3 and graphically in FIG. 9 is obtained from the power generator/seller. In step 27, the user empirically determines his target requirements for energy based on his daily operations. In step 28, the user computes his un-optimized costs based on using the energy on a 24-hour basis with no cost-driven re-allocation of energy during the day. In step 29, the user formulates the hourly upper 22, lower 23 and equality constraints which limit the use of energy during the day. These constraints shown in FIG. 4 as a table and in FIG. 12 as a graph with 58 showing the lower limit curve and 59 the upper limit curve. These constraints are formulated in steps 30, 31, 32. In step 33, the optimization model is formulated. The formulation involves setting up the objective function shown by Eq. 1 in the optimization section earlier in this filing. Eq. 1 shows the summation over all time intervals of the product of the cost of energy “Cⱼ” times the amount of power used “Xⱼ” in each time interval “j”. In this example, the objective is a linear function but this in no way limits the application of the invention to linear, non-linear and integer type formulations.

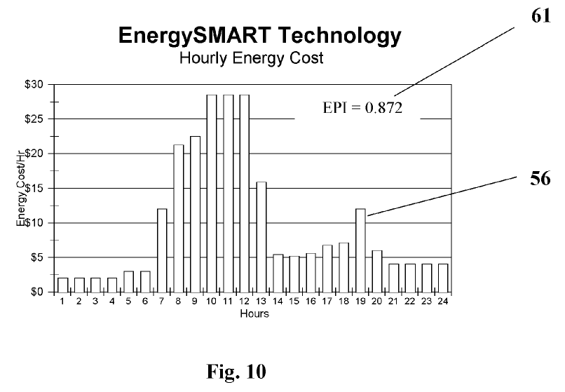

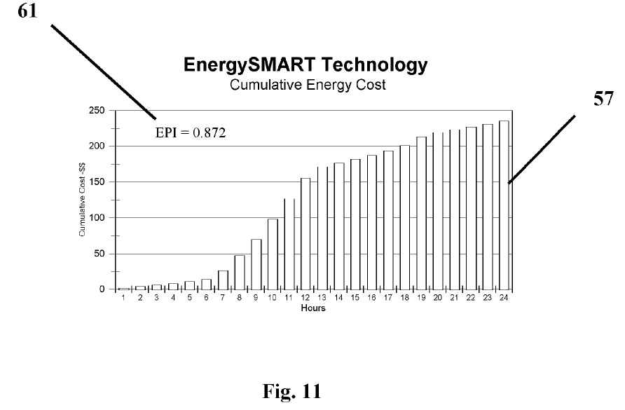

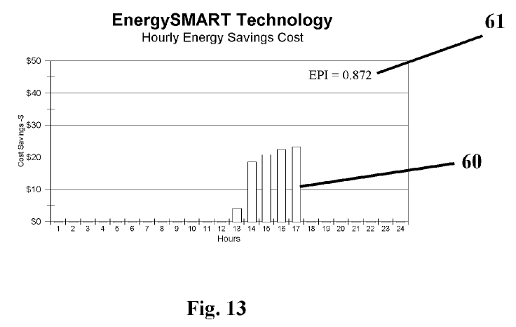

The invention can be generalized to utilize both linear and non-linear models. The complete model as shown collectively in Eqs. 1, 2, 3 is then solved in step 34, 35 and 36 using published technologies and algorithms. These technologies and algorithms are not part of the invention but are well known to all involved and skilled in the art. Since these algorithms are mathematically guaranteed to provide the global optimal solution, in step 37 the absolute minimum cost of energy in the total time periods is computed and is the actual value of the objective function when the model is solved. Hourly results of the optimization model are shown in the table in FIG. 5, where optimized variables 24 and cumulative variables 25 are shown and graphically displayed in FIG. 10. The cumulative value 25 of energy costs is shown in FIG. 11. The actual energy savings 60 in each hour of the day is shown in FIG. 13. The total cost savings indicate the benefit of this invention compared to using non-optimized approaches. The Energy Performance Index (EPI) 61, is a factor defined by and computed from the un-optimized data and the optimized absolute minimum cost of energy is computed in step 38 as follows in Eq. 5. The computed ratio of the optimized absolute minimum cost of available energy is used in a given period of time that meets all the operational constraints and target values relative to actual un-optimized cost of energy during the same time period is the EPI, 61.
ΣCⱼ*Xoptⱼ
EPI=______ Eq.5
ΣCⱼ*Xun−optⱼ
where: Xopt_{j and} Xun-optⱼ are the optimized and un-optimized values respectively of energy used at each hour “j”.

To utilize this technology for a large number of customers, as is normally required in a utility environment; various enhancements are included in this invention. The process in this embodiment is contemplated to be an iteration loop between all the customers using online systems or clusters of computers on a grid network substantially in real time. To start the loop, as shown in step 43, the input data of time 20, and energy cost 21 from TOU tariffs is obtained from the internet via the world wide web or from email communications or some similar type communication mode. The optimization model in step 44 is set up online or on a desktop computer. The computer program that contains the optimization applications can reside on a server or on a desktop as shown in step 45. In step 46 solving the applications provide the required outputs, which are used in step 47 to generate graphic information in step 52, and tabular information in step 53. The customer data in steps 52, 53 is downloaded to the user in step 49 or made available on the Internet in step 50. The data is also transmitted to the user by any of several existing communication modes in step 51. In step 55, the loop is incremented and the next customer's operations are analyzed starting again at step 42. In step 54, the data is archived for future use and for comparative analysis.

After reading the above detailed embodiment of the subject invention, it will occur to those skilled in the art that modifications and alternatives can be practiced within the spirit of the invention and accordingly the spirit and scope of the subject invention should not be limited to the specific details in the embodiments above.

List of Abbreviations:

| Abbreviation | Meaning |
|---|---|
| AMR | Automatic Meter Reader |
| ANN | Automatic Neural Network |
| API | Applications Program Interface |
| BMP | BitMap Graphic file format |
| CDMA | Code Division Multiple Access |
| CDPD | Cellular Digital Packet Data |
| CPU | Central Processing Unit |
| dB | decibel |
| DSL | Digital Subscriber Line |
| EPI | Energy Performance Index |
| FTP | File Transfer protocol |
| GB | Great Britain |
| GIF | Graphic file format - Graphic interchange format |
| GPH | Gallons per Hour |
| GSM | Global System Mobile Communication |
| GUI | Graphical User Interface |
| HP | Horse power |
| ID | Identification |
| ISP | Internet Service Provider |
| JPEG | Graphic file format - Joint Photography Group |
| KW | Kilowatt |
| OCR | Optical Character Recognition |
| OS | Operating System |
| PCS | Personal Communication Services |
| PLC | Powerline carrier |
| PSTN | Public Switched Network |
| RAM | Random Access Memory |
| RF | Radio Frequency |
| RMR | Remote Meter Reading |
| TDMA | Time Division Multiple Access |
| VPN | Virtual Private Network |
| WAP | Wireless Application Protocol |
| WWW | World Wide Web |
| x.25 | Modem usage protocol |

### REFERENCES

Ref. (1) The Williams Company, One Williams Center, Tulsa Okla.

(Ref 2.) Thermodynamics, Gordon J. Van Wylen,© 1959 John Wiley and Sons. NY.

Ref.(3) Linear Programming, Frequently Asked Questions. Optimization Technology Center of Northwestern University and Argonne National Laboratory.

http://www-unix.mcs.anl.gov/otc/Guide/faq/linear-programming-faq.html definition.

Ref (4) Introduction to Mathematical Programming. Wayne L. Winston, Munirpallam Venkataramanan, 4th ED. Thomson-Brooks/Cole, ISBN: 0-534-35964-7

1. A novel computer implemented method for optimizing the energy management and energy efficiency monitoring of a facility or a plurality of facilities, substantially in real time, using a new metric described herein, called the Energy Performance Index (EPI), including the steps of:
defining a novel metric called the energy performance index (EPI) which describes the absolute minimum cost of energy in the time period under observation, and,
deriving this new metric by defining a set of parameters for the facility system operating over a set of time intervals; and,
using a optimization technique, taking into account said set of parameters, to produce energy management output data which satisfies a total energy consumption constraint that the total energy allocated to the facility not exceed a target energy consumption level, and
which is representative of an optimal management of energy in each of said time intervals, and,
using a computer system to determine this novel metric called the energy performance index (EPI) which describes as an output, the absolute minimum cost of energy in the time period under observation, and,
using this new parameter (EPI) to compare efficiencies between a plurality of operations, and,
making the information and energy outputs available, substantially in real time.

2. The method of claim 1 for optimizing energy management comprising:
a means for defining the energy parameters;
a means for defining linear or nonlinear operational constraints;
a means for defining the linear or nonlinear objective function to be optimized;
a means for defining linear and nonlinear solution methods;
a means for defining optimal levels of energy use parameters;
a means for defining optimal levels of energy costs;
a means for defining the use of outputs.

3. The method as set forth in claim 1 which defines a new metric, the Energy performance Index, (EPI).

4. The method as set forth in claim 1 describing the use of the new metric EPI in the energy management industry.

5. The method as set forth in claim 1, wherein the using step is carried out by formulating a optimization problem in terms of a set of facility energy management constraints, converting said constraints into a set of constraint equations and a cost function, converting said constraint equations into a set of simultaneous linear or nonlinear equations, and then solving said set of simultaneous equations in such a manner as to minimize said cost function, to thereby produce said energy management output data.

6. The method as set forth in claim 1, wherein the using step is carried out by formulating a optimization problem which includes a set of constraint equations representative of a set of facility energy management constraints, and a cost function representative of the total facility energy consumption, and then solving said optimization problem in such a manner as to satisfy said total energy consumption constraint and each of said facility energy management constraints, while minimizing said cost function.

7. The method as set forth in claim 1 comprising:
a computer system having:
at least one or more processors,
a relational or similar database repository of energy data
a multi-layered software system
at least one communications interface to communicate with distributed users and servers over a network.

8. The method as set forth in claim 7 comprising a multi-layered software program and program architecture comprising:
linear and nonlinear optimization application programs;
application subsystems, middleware systems
application frameworks facilitating access to database repositories and database processes.

9. Method of claim 1 which includes the formulation of the EPI.

10. Method of claim 1 in which the computer connected to internet by a plurality of means including using at least one communication system comprising:
the Public Switched Telephone Network or,
a wireless system or,
a wired system such as a power line carrier over existing electric power lines.

11. Method in which computer of claim 7 makes data on EPI available in real time to the process facility and other operational controllers.

12. Method which uses a graphical user interface (GUI) which interacts with optimization programs of claim 7 above.

13. Method in which the GUI of claim 12 uses standard application programming interfaces (API) which are current available as standards to the industry.

14. Method in which the GUI of claim 12 has at least one external interface which includes a standards based API and a file based application system.

15. Method in which computer system of claim 7 comprising at least one communication server to communicate data over at least one communication network.

16. Method in which computer system of claim 7 is configured to administer a plurality of dissimilar legacy systems capable of operating with:
dissimilar customer systems,
dissimilar business logic and
dissimilar regulatory systems,
and over dissimilar networks.

17. Method in which the computer system of claim 7 is adapted to support a “fail-over” capability at all levels in the vent of failure and where if an individual process fails computer system shifts to another process to maintain system integrity.

18. Method in which the communication system of claim 15 can supports “fail-over” capability such that automatic routing to another system occurs if one communication system fails.

19. The method shown in claim 1 above where the output information is made available on the internet for user interaction comprising:
generating graphical data
generating tabular data
uploading data and graphics to central internet site
interfacing user with internet websites.

20. Method in which optimal data of claim 1 is made available to user by an export system, this export system capable of utilizing the following and other forms of communication; electronic mail, facsimile, by website posting, by internet chat, by direct internet messaging, paging over RF networks, by other radio based systems.

21. The computer system of claim 7, wherein said at least one communication server supports at least one of CDMA, telephone & international standards, PSTN, PCS, WAP, x.25 modem, RAM, CDPD, and TDMA environments.
